(19) United States
(12) Patent Application Publication
(10) Pub. No.: US 2013/0155455 A1
(43) Pub. Date: Jun. 20, 2013

(54) PRINTING SYSTEM, PRINTING APPARATUS, IMAGE PROCESSING APPARATUS, AND DATA CONVERSION METHOD

(71) Applicant: Naofumi UEDA, Osaka-shi (JP)

(72) Inventor: Naofumi UEDA, Osaka-shi (JP)

(21) Appl. No.: 13/709,546

(22) Filed: Dec. 10, 2012

(30) Foreign Application Priority Data
Dec. 19, 2011 (JP) 2011-277543

(51) Int. Cl. G06F 3/12

(52) U.S. Cl. CPC G06F 3/1296
USPC 358/1.15

(57) ABSTRACT

When a printing apparatus designated by a user obtains print data not capable of being printed in the printing apparatus, the printing apparatus transmits the print data to other apparatus with specification information representing a specification of the printing apparatus. In this case, the other apparatus converts the received print data to print data capable of being printed in the printing apparatus based on the specification information, and transmits the print data back to the printing apparatus. The printing apparatus prints based on the converted print data.

### CROSS-REFERENCE TO RELATED APPLICATIONS

This non-provisional application claims priority under 35 U.S.C. §119(a) on Patent Application No. 2011-277543 filed in Japan on Dec. 19, 2011, the entire contents of which are hereby incorporated by reference.

### FIELD

The present invention relates to a printing system comprising a printing apparatus and an image processing apparatus for obtaining print data which cannot be printed in the printing apparatus from the printing apparatus, and converting the print data to print data which can be printed in the printing apparatus, and to a data conversion method.

### BACKGROUND

In recent years, a printing system is offered in which a plurality of printers are arranged on a network, and any one of the printers is selected from a personal computer (PC) used by a user if necessary.

FIG. 1 is a schematic diagram showing a printing system concerning Japanese Patent Application Laid-Open No. 8-6746 (1996). For example, Japanese Patent Application Laid-Open No. 8-6746 (1996) discloses a printer system in which, when a printer (printer 20 of FIG. 1) designated by a user does not support a printer language (PDL) of received print data, a printer (printer 30 of FIG. 1) which supports the printer language (PDL) and can process the print data is selected among the other printers, the print data is transmitted to the selected printer, image data is created based on the print data by the selected printer, the created image data is received again by the printer designated by the user to print the image data.

Also, Japanese Patent Application Laid-Open No. 2003-131834 discloses an image forming apparatus in which job management means of a printing apparatus is configured to output information relevant to a processing status of data inputted from the outside to the outside when data inputted to the printing apparatus is transmitted to an information processing apparatus in order to convert the data by the information processing apparatus, and thereby when print data is transmitted to the information processing apparatus and is processed by the information processing apparatus, display of job information is required of the printing apparatus to recognize the job information.

Moreover, Japanese Patent Application Laid-Open No. 11-203091 (1999) discloses a printer system which comprises a printer selecting apparatus provided with print data receiving means, print data transmitting means, printer information collecting means, data type recognizing means, data type converting means, printer selecting means, printer information storing means, and a network I/F for connecting the respective means to an external network. In such a printer system, in a case where a trouble occurs during print, even when other printer which supports a specific PDL is not found, the specific PDL of print data is converted to a PDL which is supported by the other printer.

### SUMMARY

However, in the printer apparatus disclosed in Japanese Patent Application Laid-Open No. 8-6746 (1996), it is difficult to select the other printer which coincides with config information on a job set in a driver of a printer designated by a user (hereinafter referred to as designated printer). Moreover, even though the other printer can be selected, a case where a print result expected by a user cannot be obtained may actually arise in a point as explained below.

First, in order to control a finishing function which is a function added to a printer, such as a staple and a punch, or in order to control a double-sided printing function etc., a job control language is supported by most printers in addition to a printer language. The PJL (Printer Job Language) of a command language developed by the HP company is widely known among the job control languages, and is widely used also in printers other than those of the HP company.

Although the PJL is used to control the finishing function etc., as described above, various finishing devices are mounted in the printers, therefore commands of the PJL or set parameters are different from each other.

For this reason, since a command or a parameter which is not supported by a printer itself is disregarded when the PJL other than the PJL which can be supported by the printer itself is processed, a finishing function etc. set by the command etc. is not performed. Therefore, when a PJL portion is transmitted to the other printer without any change and is reflected in a so-called job ticket etc. by interpretation of the other printer, finish (finishing process etc.) intended by a user is not obtained.

Next, a command for controlling single-sided printing or double-sided printing for each page is supported in most printer languages. Moreover, whether the page is created as a front face or it is created as a rear face can be designated in some of the printer languages.

FIG. 2 is an explanatory diagram for explaining a difference in image formation in a printer concerning a conventional printing system. For example, in a case where designation of printing front faces of respective pages is described in a PDL command in order, such as a front side of double-sided printing, a rear side of double-sided printing, a rear side of double-sided printing, and a front side of single-sided printing, when the PDL command is executed, some printers create pages (image data) like a pattern 1 of FIG. 2 as instructed by the PDL command, or some printers create a blank dummy page as a front face before a rear face of the third page based on settings of the printers like a pattern 2 of FIG. 2 for convenience, and then create a rear face of the third page.

That is, in a case where the pattern 1 is used in the printer 20 of FIG. 1 and the pattern 2 is used in the printer 30, when image data created in the printer 30 is transmitted back to the printer 20 and the printer 20 executes a print job based on the image data, a difference arises in the number of all the pages. Therefore, when printing is charged according to the number of copies, an amount of money may vary.

Next, many printers support both of a feed direction where a longer side is designated as a scanning direction and a feed direction where a shorter side is designated as a scanning direction, as for an A4 size or a letter size. Even though a sheet of the same size is set to a sheet feed tray, in a case where a feed direction of the printer 20 is different from a feed direction of the printer 30, when the printer 20 is not provided with a function for rotating received image data 90 degrees or −90 degrees, printing will be stopped until a user sets a sheet in conformity with a feed direction, and thereby the productivity may decrease unnecessarily.

Moreover, since there is a possibility that a direction of a created image varies according to respective printers even though the printer 20 is provided with the function for rotating, a printing result can be different from that intended by a user.

FIG. 3 is an explanatory diagram for explaining a problem occurring by a difference in a feed direction of a sheet in the conventional printing system. For example, in a case of an image to be created in a portrait of A4 as shown in (a) of FIG. 3, when image data is created in the printer 30 so that the image data is printed in a sheet whose longer side is designated as a feed direction, an image of (b) of FIG. 3 or (c) of FIG. 3 is obtained with respect the feed direction as a result of image handling by the printer.

However, the created image data is bit map data. Thus, even though the image data is simply transmitted to the printer 20 again, the printer 20 can determine that such an image is created so as to be fitted to the sheet whose longer side is designated as the feed direction according to the vertical and horizontal numbers of pixels, but the printer 20 cannot recognize an orientation in which the image is created. Therefore, the printer 20 cannot recognize a direction for rotating 90 degrees. As a result, a rotation result as shown in (d) of FIG. 3 or (e) of FIG. 3 is obtained, and is sometimes different from a printing result expected by a user.

Next, even though a sheet size is the same, an effective image area in which an image is actually formed on the sheet varies according to a difference in a printout mechanism for each printer, as shown in FIG. 4. That is, most printers perform a process of creating image data in an image area smaller than that restricted by each printout mechanism instead of an image area to a physical sheet size, thereby using memories attached in the printers effectively.

That is, for example, in a case where said effective image area varies according to the printer 20 and the printer 30, and in a case where the effective image area of the printer 20 is larger than that of the printer 30, a problem that a periphery portion of an image is chipped arises when the printer 20 prints based on image data created by the printer 30.

However, the above-mentioned problems are not touched upon in the printing system disclosed in Japanese Patent Application Laid-Open No. 8-6746 (1996), the image forming apparatus disclosed in Japanese Patent Application Laid-Open No. 2003-131834, and the printer system disclosed in Japanese Patent Application Laid-Open No. 11-203091 (1999), and the problems cannot be solved.

The present invention has been made with the aim of solving the above problems, and it is an object of the invention to provide a printing system, a printing apparatus, an image processing apparatus, and a data conversion method, in which one apparatus designated by a user transmits print data non-printable in the one apparatus itself to the other apparatus with specification information representing a specification of the one apparatus, and the other apparatus converts the received print data to print data printable in the one apparatus based on the specification information and transmits it back to the one apparatus, and thereby the one apparatus can execute a print job exactly and as requested by a user even though print data is print data which cannot be printed by the one apparatus.

A printing system according to the present invention is a printing system comprising a printing apparatus which prints an image based on print data, and an image processing apparatus which obtains impossible print data non-printable by the printing apparatus from the printing apparatus, and converts the impossible print data to possible print data printable by the printing apparatus, wherein said printing apparatus comprises a transmitting section which transmits specification information representing a specification of the printing apparatus itself to the image processing apparatus, and the image processing apparatus converts the obtained impossible print data to the possible print data based on the received specification information.

In the present invention, the transmitting section of the printing apparatus transmits specification information representing a specification of the printing apparatus itself to the image processing apparatus. The specification information contains information on a sheet feed tray of the printing apparatus, a usable sheet, an image formation area on a sheet, etc., for example. The image processing apparatus converts the impossible print data obtained from the printing apparatus to the possible print data based on the specification information received from the printing apparatus.

A printing system according to the present invention is characterized in that the print data contains image data concerning a print job and job control information concerning the print job, and the printing apparatus comprises a storage section which extracts the job control information from impossible print data to be transmitted to the image processing apparatus, and stores the job control information.

In the present invention, the printing apparatus extracts the job control information from the impossible print data to be transmitted to the image processing apparatus. The extracted job control information is stored in the storage section.

A printing apparatus according to the present invention is a printing apparatus which transmits impossible print data non-printable by the printing apparatus itself to an external apparatus for obtaining print data and converting the print data, obtains the converted print data from the external apparatus, and prints an image based on the converted print data, comprising a transmitting section which transmits specification information representing a specification of the printing apparatus itself to the external apparatus.

In the present invention, the transmitting section transmits specification information representing a specification of the printing apparatus itself to the external apparatus. The external apparatus converts the impossible print data obtained from the printing apparatus to print data based on the specification information received from the printing apparatus.

An image processing apparatus according to the present invention is an image processing apparatus which obtains impossible print data non-printable by an external apparatus from the external apparatus for printing an image based on print data, and performs a predetermined data conversion with respect to the impossible print data, wherein the image processing apparatus obtains specification information representing a specification of the external apparatus, and converts the impossible print data based on the specification information.

In the present invention, the image processing apparatus obtains specification information sent from the external apparatus. The image processing apparatus converts the impossible print data obtained from the external apparatus based on the obtained specification information.

A data conversion method according to the present invention is a data conversion method by a printing system provided with a printing apparatus which prints an image based on print data, and with an image processing apparatus which obtains impossible print data non-printable by the printing apparatus from the printing apparatus and converts the impossible print data to possible print data printable by the printing apparatus, the data conversion method for converting the impossible print data to the possible print data, comprising: a transmission step of the printing apparatus transmitting specification information representing a specification of the printing apparatus to the image processing apparatus; and a step of the image processing apparatus converting the obtained impossible print data to the possible print data based on the received specification information.

In the present invention, the printing apparatus transmits specification information representing a specification of the printing apparatus itself to the image processing apparatus. The image processing apparatus receives the specification information from the printing apparatus, and converts the impossible print data obtained from the printing apparatus to the possible print data based on the received specification information.

According to the present invention, when print data obtained by a printing apparatus designated by a user is print data which cannot be printed in the printing apparatus, the printing apparatus transmits the print data to other apparatus with specification information representing a specification of the printing apparatus itself, and the other apparatus converts the received print data to print data which can be printed in the printing apparatus based on the specification information, and transmits it back to the printing apparatus, and thereby even though the printing apparatus obtains print data which cannot be printed in the printing apparatus itself, the printing apparatus designated by a user can execute a print job exactly and as requested by a user.

The above and further objects and features will more fully be apparent from the following detailed description with accompanying drawings.

### BRIEF DESCRIPTION OF THE DRAWINGS

FIG. 1 is a schematic diagram showing a printing system concerning Japanese Patent Application Laid-Open No. 8-6746 (1996).

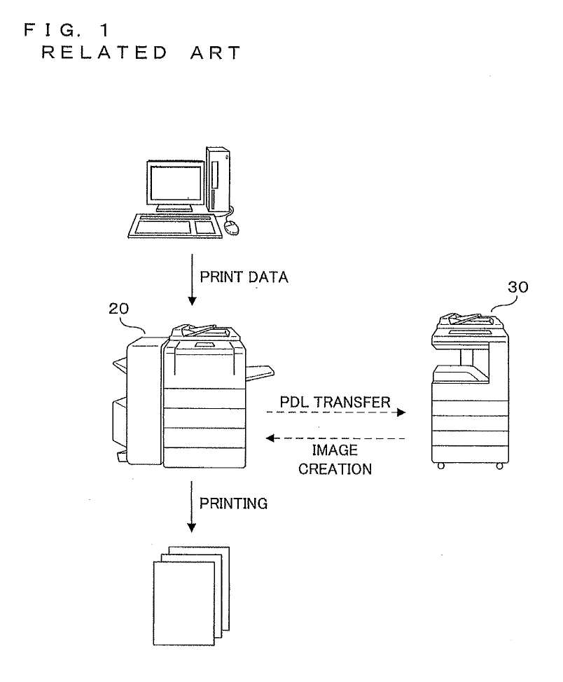

FIG. 2 is an explanatory diagram for explaining a difference in image formation in a printer concerning a conventional printing system.

FIG. 3 is an explanatory diagram for explaining a problem occurring by a difference in a feed direction of a sheet in the conventional printing system.

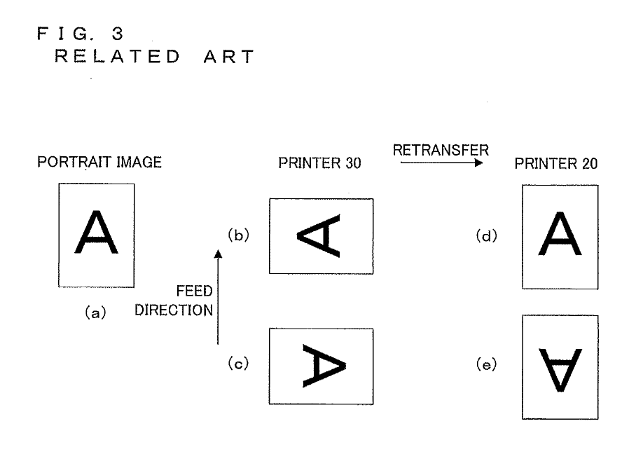

FIG. 4 is an explanatory diagram for explaining a problem occurring by a difference in a printout mechanism in the conventional printing system.

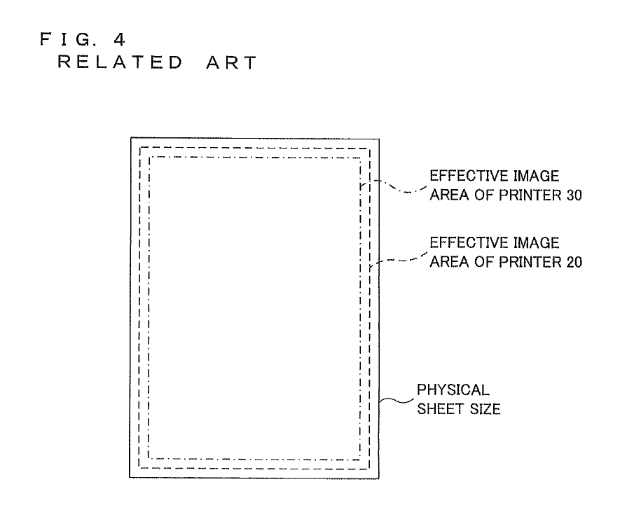

FIG. 5 is a schematic diagram showing a schematic configuration of a printing system according to Embodiment of the present invention.

FIG. 6 is a functional block diagram showing an essential configuration of a personal computer in the printing system according to Embodiment of the present invention.

FIG. 7 is a functional block diagram showing an essential configuration of a multi-function peripheral in the printing system according to Embodiment of the present invention.

FIG. 8 is a functional block diagram showing an essential configuration of an image-process control section of the multi-function peripheral in the printing system according to Embodiment of the present invention.

FIG. 9 is a flow chart showing an example of a data conversion process in the printing system according to Embodiment of the present invention.

FIG. 10 is a flow chart showing the example of the data conversion process in the printing system according to Embodiment of the present invention.

FIG. 11 is a flow chart showing the other example of a data conversion process in the printing system according to Embodiment of the present invention.

FIG. 12 is a conceptual diagram showing conceptually image data created by an image data creating section in the multi-function peripheral of the printing system according to Embodiment of the present invention.

FIG. 13 is a conceptual diagram showing conceptually a page ticket created by a page ticket creating section in the multi-function peripheral of the printing system according to Embodiment of the present invention.

### DETAILED DESCRIPTION OF NON-LIMITING EXAMPLE EMBODIMENTS

The following description will explain an example in which a printing system, a printing apparatus, an image processing apparatus and a data conversion method according to Embodiment of the present invention are applied to a printing system comprising a personal computer (PC), a multi-function peripheral and a printer, based on the drawings in detail.

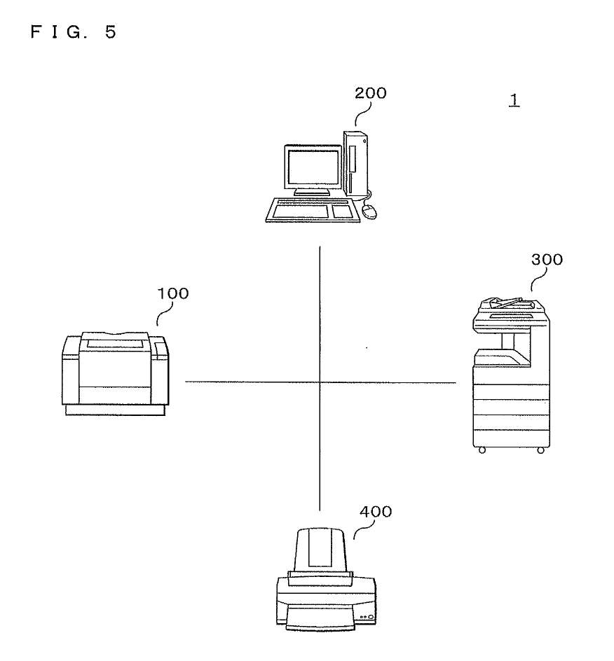

FIG. 5 is a schematic diagram showing a schematic configuration of a printing system 1 according to Embodiment of the present invention. The printing system 1 according to Embodiment of the present invention comprises printers 100, 400, a personal computer 200, and a multi-function peripheral 300. The personal computer 200 creates data concerning an image of a document to be printed (hereinafter referred to as print data), and transmits the print data to the printer 100, printer 400 or multi-function peripheral 300. The printer 100, printer 400 or multi-function peripheral 300 receives the print data, and prints a predetermined image based on the print data on a record sheet.

The print data contains image data corresponding to the image of the document, and so-called job ticket information and page ticket information. The job ticket information has setting data of a print job containing processing information after printing, setting information for printing, etc. As the job ticket information, there is a job attribute (a resolution, a gradation, etc.), a finishing setting (a punch, a staple, etc.), and the like, for example.

The page ticket information has attribute setting data for each page in printing of an image of a document. The page ticket information contains a sheet size, an orientation of an image, a rotational angle of an image, and an object of charging etc. for example.

In the printing system 1 according to Embodiment of the present invention, when print data transmitted from the personal computer 200 is print data which cannot be processed in one apparatus of the printers 100, 400 and the multi-function peripheral 300 for a reason that the print data cannot be interpret by the one apparatus (hereinafter referred to as impossible print data), the impossible print data is transmitted to one of the other apparatuses, and it converts the impossible print data to print data which can be processed in the one apparatus (hereinafter referred to as possible print data), and transmits it to the one apparatus.

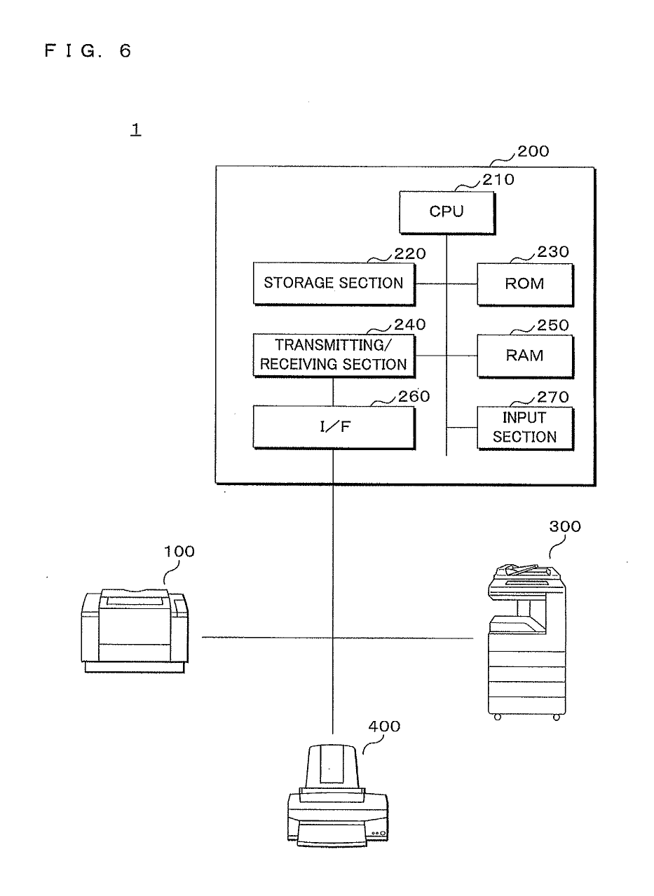

FIG. 6 is a functional block diagram showing an essential configuration of the personal computer 200 in the printing system 1 according to Embodiment of the present invention.

The personal computer 200 uses Windows of Microsoft Corp., for example, as an OS. The personal computer 200 comprises a CPU 210, a storage section 220, a ROM 230, a transmitting/receiving section 240, a RAM 250, an I/F 260, and an input section 270.

A user creates document data using an application program for providing text editing functions, such as word processing, paint, and presentation functions, and the created document data is supplied to the storage section 220 via an interface of the OS.

The CPU 210 loads on the RAM 250 a control program stored in the ROM 230 in advance and executes it, to control the above-described various hardware devices, and operates the whole apparatus as the personal computer 200 according to the present invention.

The ROM 230 stores basically fixed data etc. of various kinds of control programs and parameters for operation in advance, and the RAM 250 is capable of storing data temporarily and allows the data to be read regardless of the order and place they are stored. The RAM 250 stores, for example, a program read from the ROM 230, various kinds of data created by the execution of the program and parameters varying appropriately in a case of the execution, and the like.

The storage section 220 includes a nonvolatile storage medium, such as a flash memory, an EEPROM, an HDD, a MRAM (magnetoresistance memory), an FeRAM (ferroelectric memory), or an OUM, for example. The storage section 220 stores document data created by a user.

The transmitting/receiving section 240 is provided with a network card or a modem, etc. which transmits the document data to the outside. For example, the transmitting/receiving section 240 transmits the document data to the printer 100, printer 400 or multi-function peripheral 300 via the I/F 260.

The input section 270 is provided with a keyboard, a mouse, etc., for example. When document data is created using the application program, a user inputs data via the input section 270.

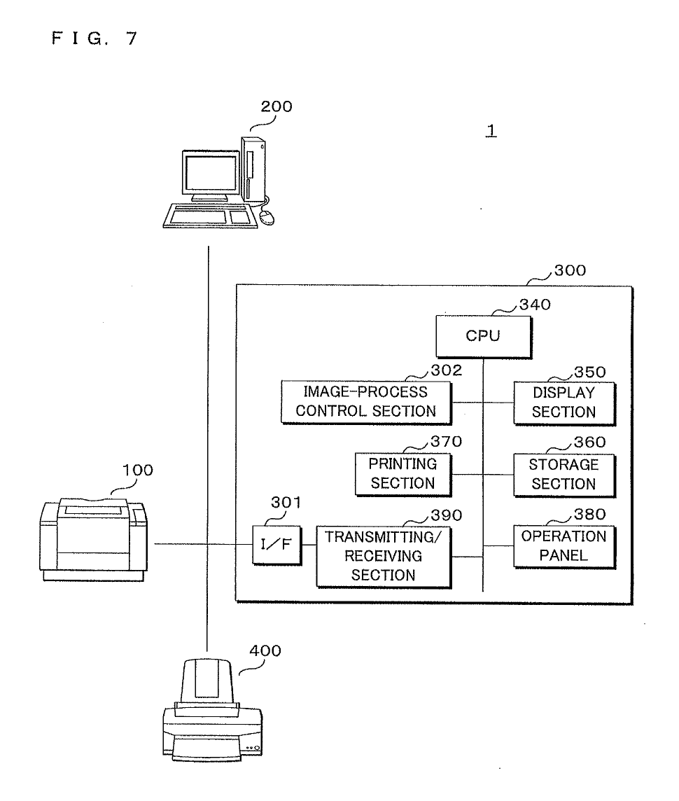

FIG. 7 is a functional block diagram showing an essential configuration of the multi-function peripheral 300 in the printing system 1 according to Embodiment of the present invention.

The multi-function peripheral 300 performs jobs, such as printing and copy, and comprises a CPU 340, an image-process control section 302, a display section 350, a printing section 370, a storage section 360, an operation panel 380, a transmitting/receiving section 390, and an I/F 301.

The CPU 340 loads on a RAM (not shown) a control program stored in a ROM (not shown) in advance and executes it, to control the above-described various hardware devices, and operates the whole apparatus as the multi-function peripheral 300 according to the present invention.

The ROM (not shown) stores basically fixed data etc. of various kinds of control programs and parameters for operation in advance, and the RAM (not shown) is capable of storing data temporarily and allows the data to be read regardless of the order and place they are stored. The RAM (not shown) stores, for example, a program read from the ROM (not shown), various kinds of data created by the execution of the program and parameters varying appropriately in a case of the execution, and the like.

The display section 350 is provided with an LCD panel or an EL (Electroluminescence) panel, for example, and displays information to be reported to a user, such as a condition of the multi-function peripheral 300, a condition of a job process, and confirmation of an operation of the operation panel 380.

The storage section 360 includes a nonvolatile storage medium, such as a flash memory, an EEPROM, an HDD, a MRAM (magnetoresistance memory), an FeRAM (ferroelectric memory), or an OUM, for example. The storage section 360 stores print data received from the personal computer 200.

The printing section 370 forms an image based on image data inputted from the image-process control section 302 on a record sheet, such as a piece of paper, by a method, such as a heat transfer method, an electro-photographic method, or an inkjet method.

The transmitting/receiving section 390 is provided with a network card or a modem, etc., and can be connected to a communication network, such as a public network (not shown), a LAN (Local Area Network), or the Internet. For example, the transmitting/receiving section 390 receives the print data from the personal computer 200 via the I/F 301, or transmits the print data to the printer 100 or the printer 400.

The operation panel 380 is provided with a numeric keypad, a power key, a function switching key, etc., and accepts from a user an instruction for controlling an operation of the multi-function peripheral 300, such as an instruction for setting a job of the multi-function peripheral 300.

The image-process control section 302 performs a predetermined process with respect to the impossible print data or possible print data transmitted from the personal computer 200, printer 100, or printer 400, or performs data conversion for converting a data format.

For example, when print data received from the personal computer 200 via the transmitting/receiving section 390 is the possible print data, the image-process control section 302 creates print data based on the image data, job ticket information and page ticket information which are contained in the possible print data, and sends the print data to the printing section 370.

When print data received from the personal computer 200 via the transmitting/receiving section 390 is impossible print data which cannot be processed in the multi-function peripheral 300, as mentioned above, the image-process control section 302 performs a predetermined process with respect to the impossible print data, and then transmits it to the printer 100 or printer 400. Thereafter, the multi-function peripheral 300 receives possible print data based on the impossible print data from the printer 100 or printer 400, and creates data for printing based on the possible print data.

Also, when impossible print data which cannot processed in the printer 100 (or printer 400) is received from the printer 100 (or printer 400) via the transmitting/receiving section 390, the image-process control section 302 performs a predetermined conversion (data conversion) with respect to the impossible print data to create possible print data which can be processed in the printer 100 (or printer 400). The possible print data thus created is transmitted to the printer 100 (or printer 400) via the transmitting/receiving section 390.

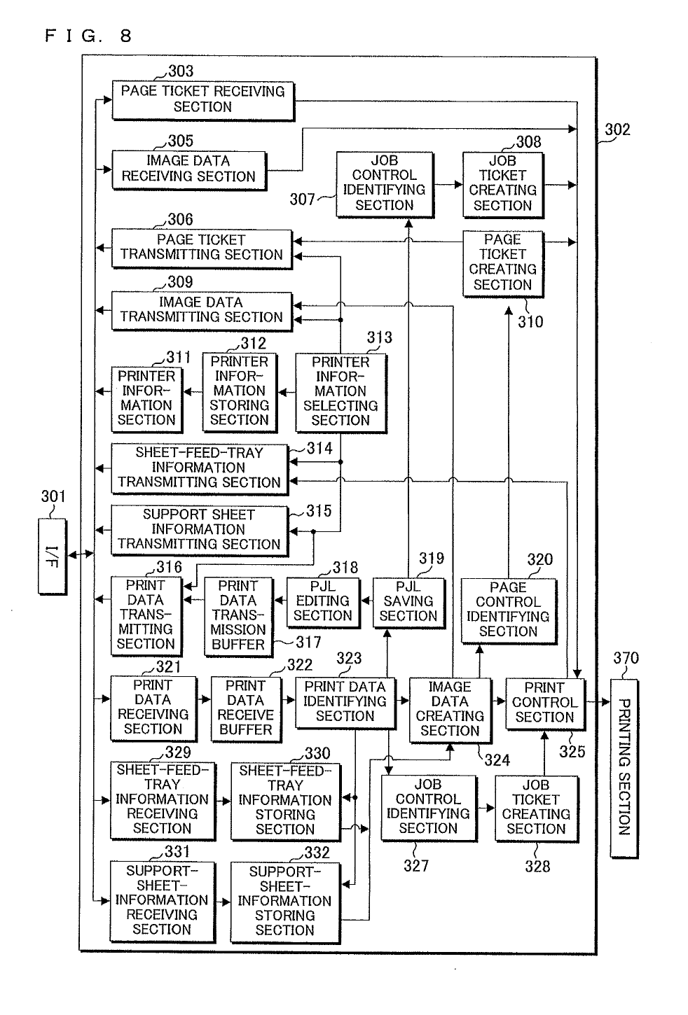

FIG. 8 is a functional block diagram showing an essential configuration of the image-process control section 302 of the multi-function peripheral 300 in the printing system 1 according to Embodiment of the present invention. The following description explains the above-mentioned conversion process in the image-process control section 302 using FIG. 8 in detail.

First, a process of interpreting a PDL of possible print data and printing the possible print data in a case where print data transmitted from the personal computer 200 and received by the multi-function peripheral 300 is the possible print data is explained.

Print data transmitted from the personal computer 200 via the I/F 301 is received by a print data receiving section 321, and is once saved in a print data receive buffer 322. A print data identifying section 323 determines whether or not a PDL of the saved print data is supported by the multi-function peripheral 300.

When it is determined that the PDL is supported, a job control identifying section 327 identifies job ticket information based on data of an added PJL portion, and extracts the identified job ticket information. A job ticket creating section 328 creates a so-called job ticket based on the extracted job ticket information.

On the other hand, a PDL portion of the received print data is sent from the print data identifying section 323 to an image data creating section 324, and a RIP (Raster Image Processer) process is performed with respect to the PDL portion to create bitmap image data of each page of a document.

When the RIP process is performed, a page control identifying section 320 extracts page ticket information on a sheet size of each page, pixel number information of a vertical direction and a horizontal direction of the created bitmap image data, orientation information of an image, front/rear information of both sides and one side information, information that whether or not it is page data for convenience as described above, and the like. A page ticket creating section 310 creates a so-called page ticket corresponding to each page based on the extracted page ticket information.

The job ticket created by the job ticket creating section 328, the bitmap image data created by the image data creating section 324, and the page ticket created by the page ticket creating section 310 are sent to a print control section 325. The print control section 325 prints an image concerning the document through the printing section 370 based on them. That is, when an image corresponding to the image data is printed by the printing section 370, the print control section 325 performs control of a double-side mechanism, feed/discharge control of each page, etc., and controls a finishing after completion of printing.

Next, a process of a case where print data received by the multi-function peripheral 300 is the impossible print data and a PDL of the impossible print data cannot be interpreted is explained. In this case, the multi-function peripheral 300 transmits the impossible print data to one of the other apparatuses (printer 100), and the printer 100 converts the impossible print data to possible print data which can be processed in the multi-function peripheral 300, and transmits it back to the multi-function peripheral 300.

The print data transmitted from the personal computer 200 via the I/F 301 is received by the print data receiving section 321, and is once saved in the print data receive buffer 322. The print data identifying section 323 determines whether or not a PDL of the saved print data is supported by the multi-function peripheral 300.

When it is determined that the PDL is not supported, the received print data is sent to a PJL saving section 319, and the PJL saving section 319 (storage section) extracts a PJL portion from the print data, and saves it. Then, the print data is sent to a PJL editing section 318.

The PJL editing section 318 deletes a PJL command peculiar to the multi-function peripheral 300, such as a finish process, a command containing a parameter, etc. And then the PJL editing section 318 performs an editing of adding a command to perform an RIP process (remote RIP) only, after the print data is transferred from the multi-function peripheral 300, and to transmit again processed print data (possible print data) to the multi-function peripheral 300, and information necessary to send back, such as a network address of the multi-function peripheral 300. The print data thus edited is sent to a print data transmission buffer 317, and is stored therein.

On the other hand, a printer information section 311 broadcasts a search command to peripheral printers via a network. When the printer connected to the network receives the search command, the printer transmits a response to the search command to the multi-function peripheral 300. The printer information section 311 can obtain, based on information contained in the received response, printer information, such as information that whether or not the peripheral printer is a printer which supports the remote RIP, a type of a supported PDL language, a support resolution, and a gradation, etc. The obtained printer information is stored in a printer information storing section 312. The printer information section 311 also transmits printer information of the multi-function peripheral 300 according to a request from one of the other printers.

A printer information selecting section 313 selects a predetermined printer based on the printer information stored in the printer information storing section 312. For example, when a PDL of print data received from the personal computer 200 cannot be interpreted by the multi-function peripheral 300, the printer information selecting section 313 searches a printer which can process the PDL based on the printer information stored in the printer information storing section 312, and selects it.

For example, when there are a plurality of printers which can process the PDL, the printer information selecting section 313 selects a printer which responds in the shortest period of time. Alternatively, when a response contains information representing an RIP process performance of a printer, the printer information selecting section 313 may select a printer whose RIP speed is fastest based on the information.

A print data transmitting section 316 reads the edited print data from the print data transmission buffer 317, and transmits it via the I/F 301 to the printer selected by the printer information selecting section 313 (hereinafter referred to as selected printer).

In this case, a sheet-feed-tray information transmitting section 314 transmits sheet-feed-tray information of a printing apparatus at the time of reception of the print data to the selected printer via the I/F 301. Here, the sheet-feed-tray information contains information on a kind of a sheet feed tray provided in a printer, a kind of a record sheet corresponding to the sheet feed tray, and the like. A support sheet information transmitting section 315 transmits sheet information concerning all the record sheets supported by the multi-function peripheral 300 (for example, a kind of a sheet size, a type of a sheet, etc.), and effective image area information, etc. via the I/F 301 to the selected printer.

Thereafter, the selected printer receives the edited print data (impossible print data), convert the print data based on the sheet-feed-tray information, the sheet information, and the effective image area information, etc. to create print data (possible print data) which can be processed in the multi-function peripheral 300 (image-process control section 302). In detail, the possible print data contains image data of each page and a page ticket for each page. The selected printer transmits the possible print data to the multi-function peripheral 300.

When the possible print data is transmitted to the multi-function peripheral 300, an image data receiving section 305 receives image data of the possible print data, and a page ticket receiving section 303 receives a page ticket of the possible print data.

In this case, a job control identifying section 307 identifies job ticket information based on a PJL portion saved in the PJL saving section 319, and extracts the identified job ticket information. A job ticket creating section 308 creates a job ticket concerning the job (printing) based on the extracted job ticket information.

The job ticket created by the job ticket creating section 308, the image data received by the image data receiving section 305, and the page ticket received by the page ticket receiving section 303 are sent to the print control section 325. The print control section 325 prints an image concerning the document through the printing section 370 based on them. That is, when an image corresponding to the image data is printed by the printing section 370, the print control section 325 performs control of a double-side mechanism, feed/discharge control of each page, etc., and controls a finishing after completion of printing.

Finally, a process of a case where print data received from the personal computer 200 is impossible print data and a PDL of the impossible print data cannot be interpreted by the printer 100 or printer 400 is explained. In this case, the printer 100 or printer 400 transmits the impossible print data to the multi-function peripheral 300, and the multi-function peripheral 300 converts the impossible print data to possible print data which can be processed in the printer 100 or printer 400, and transmits it back to the printer 100 or printer 400. For convenience of description, a case where print data transmitted from the personal computer 200 and received by the printer 100 is impossible print data, and the impossible print data is converted by the multi-function peripheral 300 and is transmitted to the printer 100 is explained as an example.

Print data (impossible print data) transmitted from the printer 100 to the multi-function peripheral 300 is received via the I/F 301 by the print data receiving section 321, and is stored in the print data receive buffer 322. In this case, the printer 100 transmits the sheet-feed-tray information concerning the printer 100, the sheet information, the effective image area information, etc., as mentioned above.

The transmitted sheet-feed-tray information is received by a sheet-feed-tray information receiving section 329, and is stored in a sheet-feed-tray information storing section 330. The transmitted sheet information and effective image area information are received by a support-sheet-information receiving section 331, and are stored in a support-sheet-information storing section 332.

Subsequently, the print data identifying section 323 identifies whether or not the print data stored in the print data receive buffer 322 is print data transferred from one of other apparatuses. The print data identifying section 323 identifies by confirming a command added to a PJL portion of the print data. In this case, information, such as a network address of a source (printer 100) transferring print data, etc. is also obtained.

When it is determined that the print data is print data transferred from the one of other apparatuses, the image data creating section 324 performs the RIP process, and thereby creates bitmap image data of each page of a document.

Thus, when the print data identifying section 323 determines that the print data is print data transferred from one of the other apparatuses, the image data creating section 324 performs the RIP process without using the sheet-feed-tray information, sheet information, and effective image area information of the multi-function peripheral 300. They are replaced with the sheet-feed-tray information of the source transferring the print data, stored in the sheet-feed-tray information storing section 330, and the sheet information and effective image area information of the source transferring the print data stored in the support-sheet-information storing section 332, and then the RIP process is performed.

When the RIP process is performed, the page control identifying section 320 extracts page ticket information on a sheet size of each page of a document, pixel number information of a vertical direction and a horizontal direction of the created bitmap image data, orientation information of an image, front/rear information of both sides and one side information, information that whether or not it is page data for convenience as described above, etc. The page ticket creating section 310 creates a page ticket of each page, based on the extracted page ticket information.

On the other hand, the image data created by the image data creating section 324 is sent not to the print control section 325, but to an image data transmitting section 309. The page ticket created by the page ticket creating section 310 is sent to a page ticket transmitting section 306. The image data and page ticket are transmitted via the I/F 301 to the printer 100 which is the source transferring the print data.

Note that the respective main sections of the image-process control section 302 as described above may be configured as a hardware logic device or as software using the CPU 340.

The configurations of the printer 100 and the printer 400 are the same as that of the multi-function peripheral 300 and detailed description thereof is omitted.

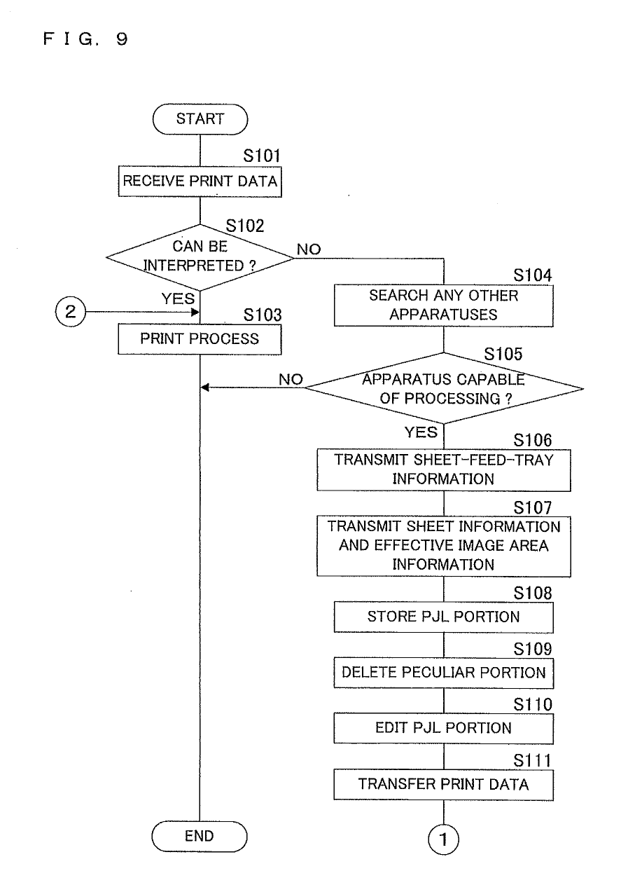

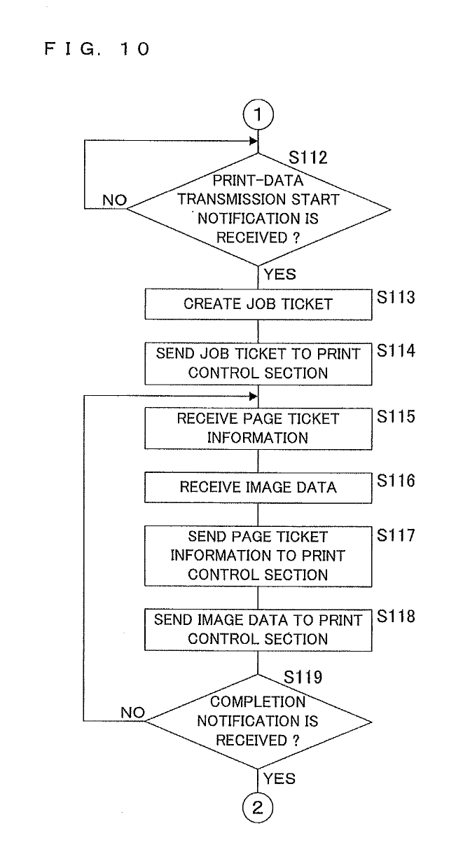

FIGS. 9 and 10 are flow charts showing an example of a data conversion process in the printing system 1 according to Embodiment of the present invention. For convenience of description, the following description explains a case where print data of a predetermined document received with a request of a print job by the multi-function peripheral 300 is the impossible print data, and a PDL of the impossible print data cannot be interpreted, therefore, the multi-function peripheral 300 transmits the impossible print data to the printer 100, and the printer 100 converts the impossible print data to possible print data which can be processed in the multi-function peripheral 300 and transmits it back to the multi-function peripheral 300.

Print data transmitted from the personal computer 200 is received by the print data receiving section 321 (Step S101), and is once saved in the print data receive buffer 322.

In this case, the print data identifying section 323 determines whether or not a PDL of print data saved in the print data receive buffer 322 is a PDL which can be interpreted by the multi-function peripheral 300 (Step S102).

When the print data identifying section 323 determines that the PDL of the print data can interpret by the multi-function peripheral 300 (Step S102: YES), the multi-function peripheral 300 performs a print process based on the print data (Step S103).

That is, the job ticket creating section 328 creates a job ticket, and the image data creating section 324 creates bitmap image data for each page by the RIP process. During the RIP process, the page ticket creating section 310 creates a page ticket corresponding to each page. The job ticket, image data, and page ticket which are created in this manner are sent to the print control section 325, and the print control section 325 performs a print job based on them through the printing section 370.

On the other hand, when the print data identifying section 323 determines that the PDL of the print data cannot be interpreted by the multi-function peripheral 300 (Step S102: NO), the printer information selecting section 313 searches any other apparatus (printers) which can process the PDL based on the printer information stored in the printer information storing section 312 (Step S104). Moreover, the printer information selecting section 313 determines whether or not there is an apparatus which can process the PDL based on a search result (Step S105), and selects one printer. Such a selection of a printer by the printer information selecting section 313 is as mentioned above, and detailed description thereof is omitted.

When the printer information selecting section 313 determines that there is no apparatus which can process the PDL (Step S105: NO), the print job is canceled.

On the other hand, when the printer information selecting section 313 determines that there is an apparatus which can process the PDL (Step S105: YES), one printer is selected. In this Embodiment, it is assumed that the printer 100 is selected by such a selection.

Subsequently, the sheet-feed-tray information transmitting section 314 transmits sheet-feed-tray information of a printing apparatus at the time of reception of the print data via the I/F 301 to the printer 100 (Step S106). The support sheet information transmitting section 315 transmits sheet information, effective image area information, etc. via the I/F 301 to the printer 100 (Step S107). The printer 100 receives the sheet-feed-tray information, the sheet information, and the effective image area information.

In this case, the PJL saving section 319 extracts a PJL portion from the print data received at Step S101 and stores it (Step S108).

Moreover, the PJL editing section 318 deletes a PJL command peculiar to the multi-function peripheral 300, a command containing a parameter, etc. (Step S109). And then the PJL editing section 318 performs an editing of adding a command to perform an RIP process only, with respect to the print data transferred from the multi-function peripheral 300 and to transmit again processed print data (possible print data) to the multi-function peripheral 300, and information necessary to send back, such as a network address of the multi-function peripheral 300 (Step S110). The print data thus edited is sent to the print data transmission buffer 317, and is stored therein.

The print data transmitting section 316 reads the edited print data from the print data transmission buffer 317, and transfers it to the printer 100 selected by the printer information selecting section 313 (Step S111).

Thereafter, the printer 100 receives the edited print data, and converts the print data based on the sheet-feed-tray information, sheet information, effective image area information, etc. to create print data (possible print data) which contains image data for each page and page ticket information of each page and which can be processed by the multi-function peripheral 300 (image-process control section 302).

The printer 100 notifies the multi-function peripheral 300 that transmission of the print data is started, before transmitting the possible print data (hereinafter referred to as print-data transmission start notification). The CPU 340 monitors the I/F 301 to determine whether or not the print-data transmission start notification is received (Step S112).

When the CPU 340 determines that the print-data transmission start notification is not received (Step S112: NO), the CPU 340 repeats the determination until the print-data transmission start notification is received.

On the other hand, when the CPU 340 determines that the print-data transmission start notification is received (Step S112: YES), the CPU 340 gives an instruction to create a job ticket to the job ticket creating section 308. According to the instruction of the CPU 340, the job ticket creating section 308 creates a job ticket based on job ticket information extracted from the PJL portion by the job control identifying section 307 and saved in the PJL saving section 319 (Step S113).

The job ticket created by the job ticket creating section 308 is sent to the print control section 325 (Step S114), and is registered in a print job.

In this case, the possible print data is transmitted from the printer 100 to the multi-function peripheral 300, the page ticket receiving section 303 receives the page ticket information transmitted with the possible print data (Step S115), and the image data receiving section 305 receives image data contained in the possible print data (Step S116).

Thus, the page ticket information received by the page ticket receiving section 303 is sent to the print control section 325 (Step S117). The image data received by the image data receiving section 305 is also sent to the print control section 325 (Step S118).

On the other hand, when the transmission of the possible print data is completed, the printer 100 notifies the multi-function peripheral 300 that the transmission of the print data is completed (hereinafter referred to as completion notification). The CPU 340 monitors the I/F 301 to determine whether or not the completion notification is received (Step S119).

When the CPU 340 determines that the completion notification is not received (Step S119: NO), it returns the process to Step S115. When the CPU 340 determines that the completion notification is received (Step S119: YES), it breaks communication with the printer 100.

Thereafter, the process proceeds to Step S103, and as described above, the print control section 325 prints through the printing section 370 based on the page ticket information, image data and job ticket.

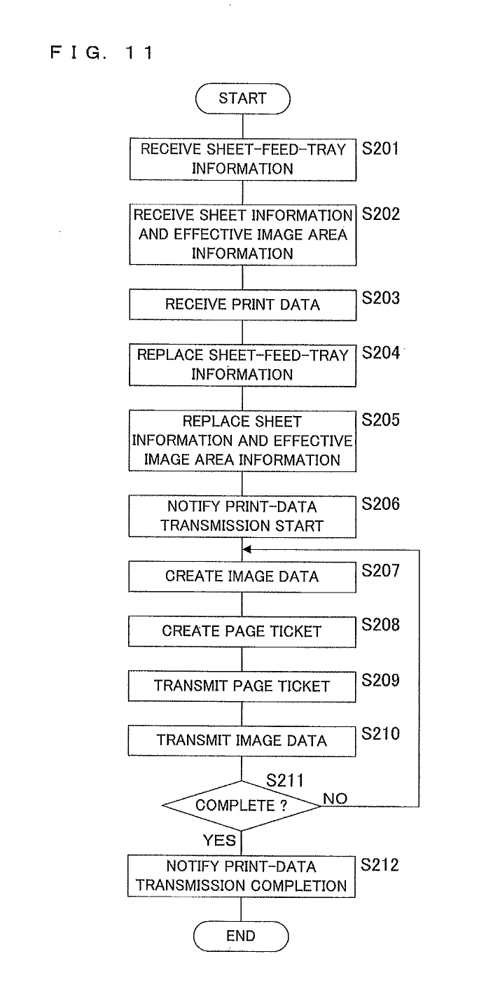

FIG. 11 is a flow chart showing the other example of a data conversion process in the printing system 1 according to Embodiment of the present invention. For convenience of description, the following description explains as an example a process of the multi-function peripheral 300 in a case where print data of a predetermined document received with a request of a print job by the printer 100 is the impossible print data, and a PDL of the impossible print data cannot be interpreted, therefore, the printer 100 transmits the impossible print data to the multi-function peripheral 300, and the multi-function peripheral 300 converts the impossible print data to possible print data which can be processed by the printer 100 and transmits it back to the printer 100.

When the multi-function peripheral 300 is selected by the printer 100 as an apparatus which can process the impossible print data, sheet-feed-tray information, sheet information and effective image area information, etc. concerning the printer 100 are transmitted to the multi-function peripheral 300 (see Step S106 and step S107).

In this case, the transmitted sheet-feed-tray information is received by the sheet-feed-tray information receiving section 329 (Step S201), and is saved in the sheet-feed-tray information storing section 330. The transmitted sheet information and the transmitted effective image area information are received by the support-sheet-information receiving section 331 (Step S202), and is saved in the support-sheet-information storing section 332.

Subsequently, the printer 100 deletes a PJL command peculiar to the printer 100, a command containing a parameter, etc., and then edits as described above and transfers the edited print data to the multi-function peripheral 300 (see Step S111).

In this case, the edited print data transmitted from the printer 100 to the multi-function peripheral 300 is received via the I/F 301 by the print data receiving section 321 (Step S203), and is stored in the print data receive buffer 322. The print data identifying section 323 obtains information, such as a network address of a source (printer 100) transferring the received print data.

Thereafter, the image data creating section 324 performs the RIP process with respect to the print data to create image data. On the other hand, the image data creating section 324 replaces the sheet-feed-tray information, the sheet information and effective image area information of the multi-function peripheral 300 before creating the image data.

That is, the image data creating section 324 replaces the sheet-feed-tray information of the multi-function peripheral 300 with the sheet-feed-tray information of the printer 100 stored in the sheet-feed-tray information storing section 330 (Step S204). Moreover, the image data creating section 324 replaces the sheet information and effective image area information of the multi-function peripheral 300 with the sheet information and effective image area information of the printer 100 stored in the support-sheet-information storing section 332 (Step S205).

Subsequently, the CPU 340 notifies the printer 100 that transmission of image data created by the image data creating section 324 is started (print-data transmission start notification) (Step S206).

In this case, the image data creating section 324 creates bitmap image data for each page by the RIP process (Step S207). During the RIP process, page ticket information of each page of a document is extracted, and the page ticket creating section 310 creates a page ticket of each page based on the extracted page ticket information (Step S208).

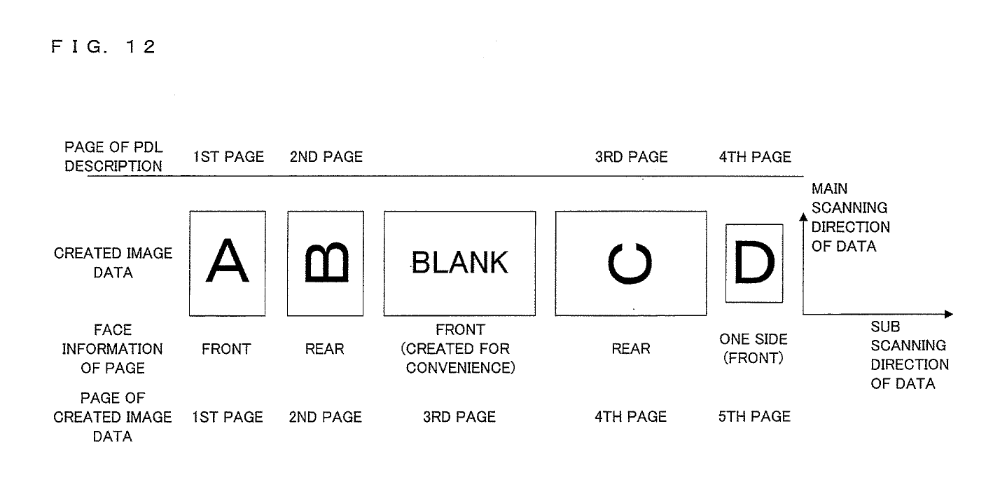

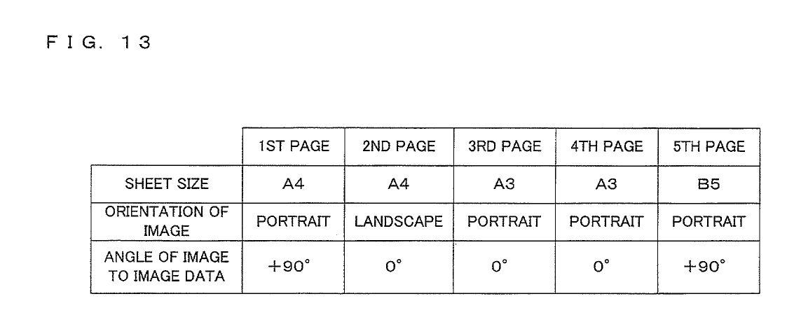

FIG. 12 is a conceptual diagram showing conceptually image data created by the image data creating section 324 in the multi-function peripheral 300 of the printing system 1 according to Embodiment of the present invention. FIG. 13 is a conceptual diagram showing conceptually a page ticket created by the page ticket creating section 310 in the multi-function peripheral 300 of the printing system 1 according to Embodiment of the present invention.

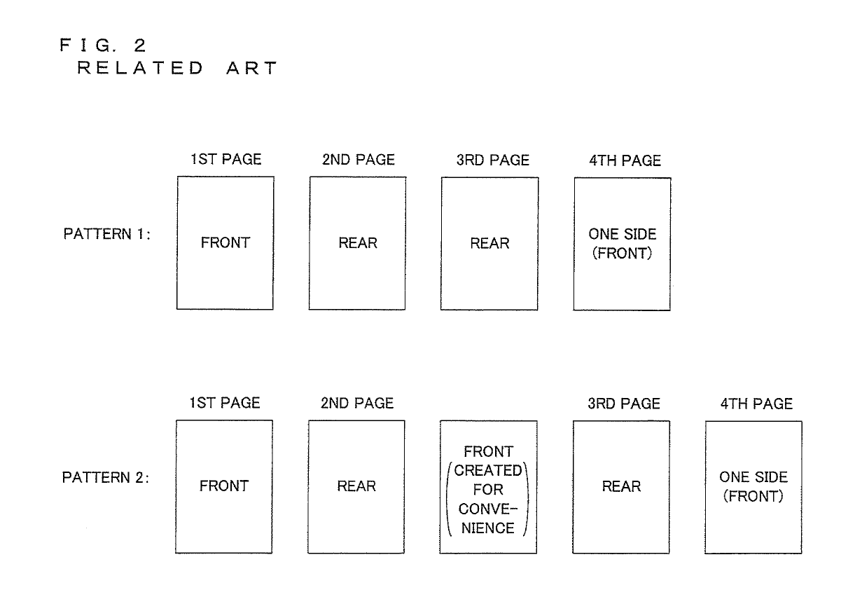

In a case where the multi-function peripheral 300 has a restriction that it cannot print unless a front face and a rear face are created in just proportion at the time of double-sided printing like the pattern 2 as shown in FIG. 2, when only one side of both sides of a sheet is described in a PDL concerning print data received from the printer 100, the multi-function peripheral 300 creates image data of the missing other side for convenience.

For example, it is assumed that a PDL description concerning print data received from the printer 100 is as follows.

The first page: front side of both sides/A4-size/portrait/drawing of “A” character

The second page: rear side of both sides/A4-size/landscape/drawing of “B” character

The third page: rear side of both sides/A3-size/portrait/drawing of “C” character

The fourth page: front side of one side/B5-size/portrait/drawing of “D” character

Moreover, it is assumed that the following is set in the multi-function peripheral 300. In A4, an image is created in a scanning direction which is a direction of a longer side, in A3, an image is created in a scanning direction which is a direction of a shorter side, and in B5, an image is created in a scanning direction which is a direction of a longer side.

In such a case, the image data creating section 324 of the multi-function peripheral 300 creates a blank dummy page between the original second page and the original third page for convenience, as shown in FIG. 12 to create image data for 5 pages which are increased by 1 page from the original as a whole.

The page ticket creating section 310 creates a page ticket as shown in FIG. 13 based on image data containing blank 1 page, as shown in FIG. 12. An attribute for identifying each page is described in the page ticket.

The page ticket transmitting section 306 transmits the page ticket created by the page ticket creating section 310 via the I/F 301 to the printer 100 which is a source transferring the print data (Step S209). The image data transmitting section 309 transmits image data created by the image data creating section 324 via the I/F 301 to the printer 100 (Step S210).

A process of creating image data from Step S207 to Step S210 as described above is performed for each page of a document. Therefore, a process of creating the image data is repeated until the last page of the document.

The CPU 340 determines whether or not a process of creating the image data until the last page of the document is completed (Step S211).

When the CPU 340 determines that the process of creating the image data is not completed (Step S211: NO), it returns the process to Step S207. On the other hand, when the CPU 340 determines that the process of creating the image data is completed (Step S211: YES), it notifies the printer 100 that transmission of image data is completed (completion notification) (Step S212), and the process is completed.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A printing system comprising a printing apparatus which prints an image based on print data, and an image processing apparatus which obtains impossible print data non-printable by the printing apparatus from the printing apparatus, and converts the impossible print data to possible print data printable by the printing apparatus,
wherein said printing apparatus comprises a transmitting section which transmits specification information representing a specification of the printing apparatus itself to the image processing apparatus, and
the image processing apparatus converts the obtained impossible print data to the possible print data based on the received specification information.

2. The printing system according to claim 1, wherein the print data contains image data concerning a print job and job control information concerning the print job, and
the printing apparatus comprises a storage section which extracts the job control information from impossible print data to be transmitted to the image processing apparatus, and stores the job control information.

3. The printing system according to claim 1, wherein the printing apparatus comprises a tray information transmitting section which transmits sheet-feed-tray information concerning a sheet feed tray and a corresponding sheet in the printing apparatus itself to the image processing apparatus, and
the image processing apparatus converts the obtained impossible print data to the possible print data based on the received sheet-feed-tray information.

4. The printing system according to claim 1, wherein the printing apparatus comprises an area information transmitting section which transmits image area information representing an effective image formation area of each sheet usable in the printing apparatus itself to the image processing apparatus, and
the image processing apparatus converts the obtained impossible print data to the possible print data based on the received image area information.

5. The printing system according to claim 2, wherein the image processing apparatus comprises a data transmitting section which transmits the converted possible print data to the printing apparatus, and
the printing apparatus prints an image based on the received possible print data and the job control information stored in the storage section.

6. The printing system according to claim 5, wherein the print data contains image data of a plurality of pages,
the image processing apparatus comprises a setting information creating section which creates page setting information representing setting information for each page in printing, based on the converted image data, and
the data transmitting section transmits the created page setting information to the printing apparatus, with the possible print data.

7. A printing apparatus which transmits impossible print data non-printable by the printing apparatus itself to an external apparatus for obtaining print data and converting the print data, obtains the converted print data from the external apparatus, and prints an image based on the converted print data, comprising
a transmitting section which transmits specification information representing a specification of the printing apparatus itself to the external apparatus.

8. The printing apparatus according to claim 7, wherein the print data contains image data concerning a print job and job control information concerning the print job, and
the printing apparatus comprises a storage section which extracts the job control information from impossible print data to be transmitted to the external apparatus, and stores the job control information.

9. The printing apparatus according to claim 7, further comprising a tray information transmitting section which transmits sheet-feed-tray information concerning a sheet feed tray and a corresponding sheet in the printing apparatus itself to the external apparatus.

10. The printing apparatus according to claim 7, further comprising a sheet information transmitting section which transmits sheet information concerning a sheet usable in the printing apparatus itself to the external apparatus.

11. The printing apparatus according to claim 7, further comprising an area information transmitting section which transmits image area information representing an effective image formation area of each sheet usable in the printing apparatus itself to the external apparatus.

12. An image processing apparatus which obtains impossible print data non-printable by an external apparatus from the external apparatus for printing an image based on print data, and performs a predetermined data conversion with respect to the impossible print data, wherein
the image processing apparatus obtains specification information representing a specification of the external apparatus, and converts the impossible print data based on the specification information.

13. The image processing apparatus according to claim 12, wherein the print data contains image data concerning a print job,
the image data contains a plurality of pages, and
the image processing apparatus comprises:
a setting information creating section which creates page setting information representing setting information of each page in printing based on the converted image data; and
a data transmitting section which transmits the created page setting information to the external apparatus, with the converted image data.

14. A data conversion method by a printing system provided with a printing apparatus which prints an image based on print data, and with an image processing apparatus which obtains impossible print data non-printable by the printing apparatus from the printing apparatus and converts the impossible print data to possible print data printable by the printing apparatus, the data conversion method for converting the impossible print data to the possible print data, comprising:
a transmission step of the printing apparatus transmitting specification information representing a specification of the printing apparatus itself to the image processing apparatus; and
a step of the image processing apparatus converting the obtained impossible print data to the possible print data based on the received specification information.
